(19) United States
(12) Patent Application Publication
(10) Pub. No.: US 2009/0231230 A1
(43) Pub. Date: Sep. 17, 2009

(54) MULTI-BAND ANTENNA WITH IMPROVED CONNECTING PORTION

(75) Inventors: Chen-Ta Hung, Tu-Cheng (TW); Hsien-Sheng Tseng, Tu-Cheng (TW); Chun-Ming Chiu, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/394,010

(22) Filed: Feb. 26, 2009

(30) Foreign Application Priority Data
Mar. 17, 2008 (TW) 97109279

(51) Int. Cl. H01Q 5/00; H01Q 1/48

(52) U.S. Cl. 343/848

(57) ABSTRACT

A multi-band antenna includes a grounding element, a connecting element, a first radiating portion and a second radiating portion. The grounding element is located on a first plane. The connecting element extends upwardly from the grounding element to be defined as an L shape and comprises a longer first side and a shorter second side. The first radiating portion includes a first side and a second side. The second radiating portion is connected to the first radiating portion on a first point. The first radiating portion together with the second radiating portion forms a Z shape. The second side of the connecting element is connected to one of the two radiating portions on a second point.

### BACKGROUND OF THE INVENTION

1. Field of the Invention

The present invention relates generally to a multi-band antenna, and more particularly to a low-structure multi-band antenna with a new-structure connecting portion.

2. Description of the Prior Art

Miniaturization is a trend for portable electric devices. Thus, components inner the portable electric devices become thinner and smaller. Antenna, which is a necessary component in present wireless communicating device, is manufactured to be smaller and lower. Planar Inverted-F Antenna (PIFA) is a type of often-used antennas inner electrical devices. The present PIFA always uses planar three-pieces structure to form its connecting portion. However, the planar three-pieces structure has two pieces extending along the same direction. Thus, the connecting portion with three-pieces structure is not fit for reduce the length along the direction along which the two pieces extends of the antenna.

Hence, in this art, a multi-band antenna to overcome the above-mentioned disadvantages of the prior art should be provided.

### BRIEF SUMMARY OF THE INVENTION

A primary object, therefore, of the present invention is to provide a multi-band antenna with low structure.

In order to implement the above object, the multi-band antenna includes a grounding element, a connecting element, a first radiating portion and a second radiating portion. The grounding element is located on a first plane. The connecting element extends upwardly from the grounding element to be defined as an L shape and comprises a longer first side and a shorter second side. The first radiating portion includes a first side and a second side. The second radiating portion is connected to the first radiating portion on a first point. The first radiating portion together with the second radiating portion forms a Z shape. The second side of the connecting element is connected to one of the two radiating portions on a second point.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view illustrating a first embodiment of a multi-band antenna in according with the present invention; and

FIG. 2 is a perspective view illustrating a second embodiment of a multi-band antenna in according with the present invention.

### DETAILED DESCRIPTION OF THE INVENTION

Reference will now be made in detail to a preferred embodiment of the present invention.

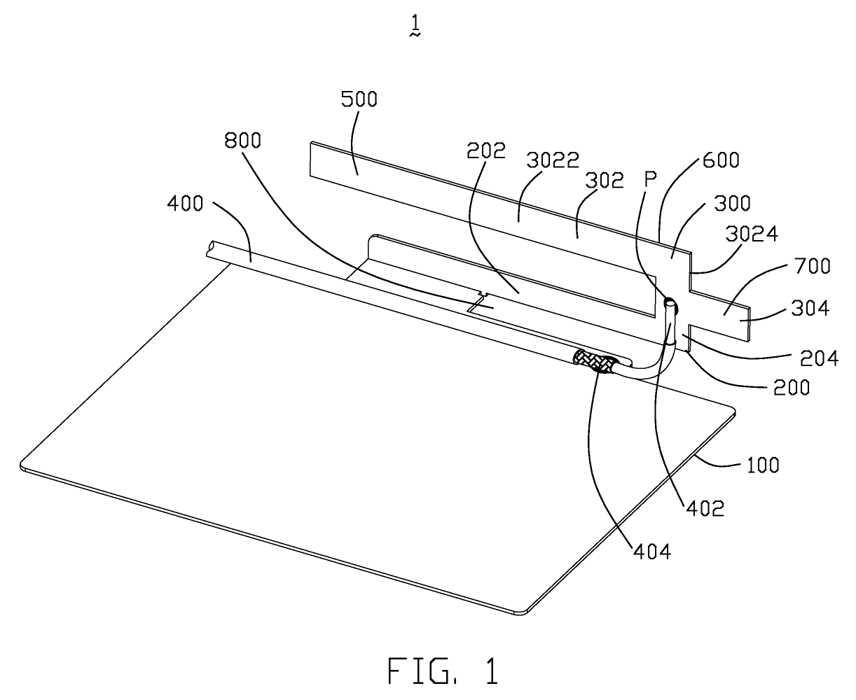

Reference to FIG. 1, a multi-band antenna in according with a first embodiment of the present invention is shown. The multi-band antenna 1 is assembled in a notebook computer (not shown) and comprises a grounding element 100, a conductive metal sheet 500 and a feeding line 400. The conductive metal sheet 500 comprises a U-shape first conductive piece 600 and a second linable conductive piece 700 extending from one of the points on the bottom side of the first conductive piece 600 except two terminal points. The grounding element 100 is located on a first plane and the metal sheet 500 is located on a second plane perpendicular to the first plane. In other embodiment, the grounding element 100 is able to be designed to be other configurations and just comprise a part thereof located on the first plane.

The first conductive piece 600 of the metal sheet 500 comprises an L-shape first portion to be used as a connecting portion 200, and an L-shape second portion to be used as a first radiating portion 302. The second conductive piece 700 is used as a second radiating portion 304. The first radiating portion 302 together with the second radiating portion 304 forms the radiating element 300.

The connecting element 200 comprises a longer first side 202 and shorter second side 204. The first side 202 is the lower side arm of the first conductive piece 600 to be connected to the grounding element 100. The second side 204 is connected to the radiating element 300. A slot 800 is formed between the first side 202 and the grounding element 100, which is made by cut a part of the grounding element 100.

The radiating element 300 is of Z shape configuration. The first radiating portion 302 comprises a longer arm 3022 with an end extending along the first direction, and a short arm 3024 connected to the second radiating portion 304 which has an end extending along the second direction.

The feeding line 400 comprises an inner conductor 402 connected to a first point P which is the joint point of the first radiating portion 302 and the second radiating portion 304, and an outer conductor 404 connected to the grounding element 100. One end of the second side 204 of the connecting portion 200 is connected to the first point P.

In other embodiment, the location of the first point P can be moved along vertical direction to be adapted to a radiating element with different length from the radiating element 300 in the first embodiment.

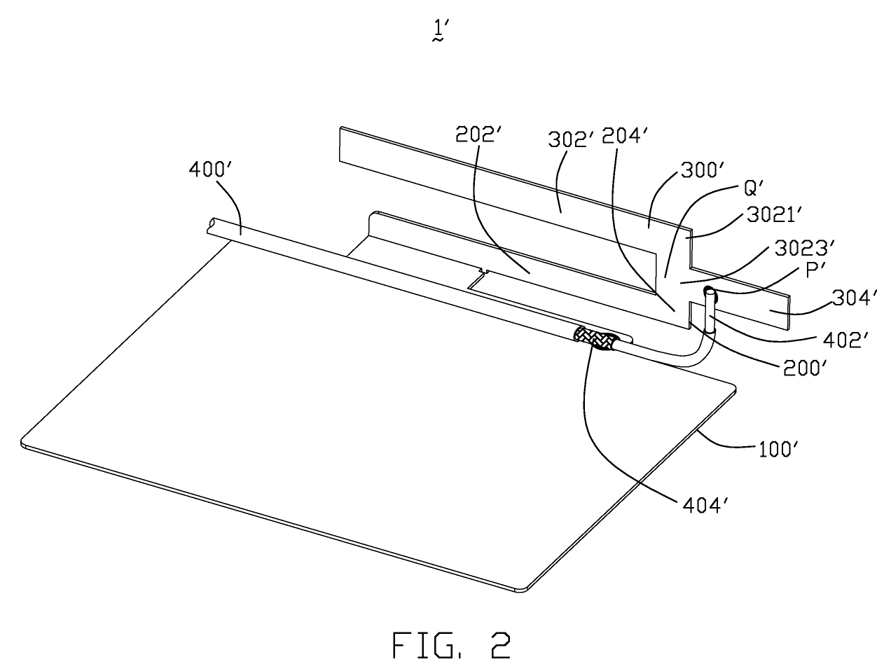

Reference to FIG. 2, a multi-band antenna 100′ according to the second embodiment of the present invention is shown. The difference between the multi-band antenna 100 in according with the first embodiment and the multi-band antenna 100′ from the second embodiment is that the first point P of the multi-band antenna 100 is moved rightward to form the first point P′ of the multi-band antenna 100′ and the lengths of the first and second radiating portion have been changed. The multi-band antenna 100′ comprises a grounding element 100′, a connecting element 200′ and a radiating element 300′ and a feeding line 400′. The grounding element 100′ is located on a first plane. The connecting element 200′ and the radiating element 300′ are located on a second plane perpendicular to the first plane. The connecting element 200′ is of L-shape configuration and comprises a longer first side 202′ connected to the grounding element 100′ and a shorter second side 204′ connected to the radiating element 300′. The radiating element 300′ is Z shape and comprises a first radiating portion 302′ and a second radiating portion 304′ connected to the first radiating portion 302′ on the first point P′. The second arm 204′ of the connecting element 200′ is connected to the second radiating portion 304′ on a second point Q′. The first point P′ is separated from the second point Q′ to form a certain distance between the two points. The feeding line 400′ comprises an inner conductor 402′ connected to the first point P′ and an outer conductor 404′ connected to the grounding element 100′. Two bending portion 3021′, 3023′ are defined on the first radiating portion 302′ to make the first radiating portion 302′ form a Z-shape configuration. The second radiating portion 304′ extends along a horizontal direction.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

What is claimed is:

1. A multi-band antenna, comprising:
a grounding element, located on a first plane;
a connecting element, extending upwardly from the grounding element to be defined as an L shape and comprising a longer first side and a shorter second side;
a first radiating portion; and
a second radiating portion, connected to the first radiating portion on a first point;
said first radiating portion together with the second radiating portion forming a Z shape, said second side of the connecting element being connected to one of the two radiating portions on a second point.

2. The multi-band antenna as claimed in claim 1, wherein a slot is formed between the grounding element and the connecting element, and the first side of the connecting element is connected to the grounding element.

3. The multi-band antenna as claimed in claim 1, wherein said first point and the second point overlap each other.

4. The multi-band antenna as claimed in claim 1, wherein said first point is separated from the second point to form a certain distance between the two points.

5. The multi-band antenna as claimed in claim 1, wherein said first radiating portion, the second radiating portion and the connecting element are located on a second plane perpendicular to the first plane.

6. The multi-band antenna as claimed in claim 1, wherein said feeding line comprises an inner conductor connected to the first point and an outer conductor connected to the grounding element.

7. A multi-band antenna, comprising:
a grounding element;
a conductive metal sheet, perpendicular to the grounding element and comprising a U-shaped first conductive piece and a linable second conductive piece extending from an intermediate portion of the U-shaped first conductive piece;
a feeding line, comprising an inner conductor connected to the second conductive piece; and
a slot, being formed between a lower side arm of the U-shaped first conductive piece and the grounding element.

8. The multi-band antenna as claimed in claim 7, wherein said first conductive piece comprises an L-shape first portion to be used as a connecting portion, and an L-shape second portion together with the second conductive piece to be used as a radiating element of the multi-band antenna.

9. The multi-band antenna as claimed in claim 8, wherein said second portion is used as a first radiating portion and the second conductive piece forms the second radiating portion.

10. The multi-band antenna as claimed in claim 9, wherein said first radiating portion is connected to the second radiating portion on a first point and the connecting element is connected to the first radiating element on a second point.

11. The multi-band antenna as claimed in claim 10, wherein said first point overlaps to the second point.

12. The multi-band antenna as claimed in claim 10, wherein said first point is separated from the second point to form a certain distance between the two points.

13. The multi-band antenna as claimed in claim 10, wherein said multi-band antenna further comprises a feeding line, said feeding line comprises an inner conductor connected to the first point and an outer conductor connected to the grounding element.

14. The multi-band antenna as claimed in claim 7, wherein said first conductive piece is connected to the second conductive piece on a first point.

15. The multi-band antenna as claimed in claim 14, wherein said multi-band antenna comprises a feeding line.

16. The multi-band antenna as claimed in claim 15, wherein said feeding line comprises an inner conductor connected to the first point and an outer conductor connected to the grounding element.

17. The multi-band antenna as claimed in claim 15, wherein said feeding line comprises an inner conductor connected to the second conductive piece on a second point and an outer conductor connected to the grounding element, said second point being separated from the first point to form a certain distance between the two points.

18. A multi-band antenna comprising:
a grounding element;
a radiating element spaced from the grounding element, and defining a first radiating portion and a second radiating portion essentially extending opposite to each other and located at different upper and middle levels above the grounding element; and
a connecting element linked between the grounding element and the radiating element and essentially located at a lower level above the grounding element; wherein
a slot is formed between the connecting element and the grounding element.

19. The multi-band antenna as claimed in claim 18, further including a feeder cable having an outer conductor mechanically and electrically connected to the grounding element, and a inner conductor mechanically and electrically connected to the radiating element.

20. The multi-band antenna as claimed in claim 19, wherein said grounding element defines a two steps structure facing and connected to the connecting element.
